(19) United States
(12) Patent Application Publication
(10) Pub. No.: US 2016/0343301 A1
(43) Pub. Date: Nov. 24, 2016

(54) ELECTRONIC DEVICE AND IMAGE PROCESSING METHOD THEREOF

(71) Applicant: Samsung Electronics Co., Ltd., Gyeonggi-do (KR)

(72) Inventors: Seung Hwan CHOI, Gyeonggi-do (KR); Eung Seo SHIN, Seoul (KR); Young Bae JANG, Seoul (KR)

(21) Appl. No.: 15/155,154

(22) Filed: May 16, 2016

(30) Foreign Application Priority Data
May 22, 2015 (KR) 10-2015-0072032

(51) Int. Cl. G09G 3/3233; G09G 3/20

(52) U.S. Cl. CPC G09G 3/3233; G09G 3/2003; G09G 2300/0452; G09G 2320/0257; G09G 2320/046

(57) ABSTRACT

An electronic device is provided, including a display configured to display an image by a plurality of pixels. A nonvolatile memory is configured to store accumulated stress values for respective subpixels that are included in the plurality of pixels, and a processor is configured to change brightness of at least one peripheral subpixel arranged adjacent a corresponding subpixel if the accumulated stress value of at least one subpixel is over a threshold value.

### CLAIM OF PRIORITY

This application claims the benefit of priority under 35 U.S.C. §119(a) from a Korean patent application filed on May 22, 2015 in the Korean Intellectual Property Office and assigned Serial number 10-2015-0072032, the entire disclosure of which is hereby incorporated by reference.

### BACKGROUND

1. Field of the Disclosure

The present disclosure relates to an image processing method for a display.

2. Description of the Related Art

With advancement of electronic technology, many electronic products are developed and supplied in various ways. For example, electronic devices including displays, such as smart phones, smart TVs, tablet computers, and so on, are widely utilized by customers in recent years. According to this tendency of widespread use, a variety of displays have been developed in the forms of plasma display panel (PDP), liquid crystal display (LCD), organic light emitting diode (OLED), and so on. Such displays can be employed in electronic devices. Especially, OLED is widely employed as a display in an electronic device because OLEDs have plentiful color reproduction, a high response rate, a high contrast ratio, a wide viewing angle, and other advantages.

As for an OLED panel, there can be functional degradation issues at specific pixels in the case of continuous display by the same screen, causing a burn-in effect to generate a residual image. To lessen or delay the burn-in effect, several technologies such as color adjustment or pixel shift are proposed in continuation. However, it may be inevitable, considering the characteristics of OLED, to radically prevent the burn-in effect. The proposed technologies merely delay the burn-in effect, which is insufficient to compensate the functional degradation due to the burn-in effect.

### SUMMARY

Aspects of the present disclosure address at least some of the above-mentioned problems and/or disadvantages and to provide at least the advantages described below. Accordingly, an aspect of the present disclosure is to provide an electronic device, and an image processing method, capable of lessening a burn-in effect to prevent in order to prevent a user from noticing the burn-in effect in an OLED display.

In accordance with an aspect of the present disclosure, an electronic device may include a display configured to display an image by a plurality of pixels, a nonvolatile memory configured to store accumulated stress values for respective subpixels that are included in the plurality of pixels, and a processor including circuitry configured to control brightness of at least one peripheral subpixel locating around (i.e. adjacent) a corresponding subpixel if the accumulated stress value of at least one subpixel is over a threshold.

In accordance with another aspect of the present disclosure, an image processing method for an electronic device may include storing in a non-transitory memory accumulated stress values for respective subpixels that are included in a display, and changing a brightness of at least one peripheral subpixel locating around a corresponding subpixel if the accumulated stress value of one of the subpixels is over a threshold.

In accordance with still another aspect of the present disclosure, a computer-readable recording medium may record a program including storing accumulated stress values for respective subpixels that are included in a display, and changing brightness of at least one peripheral subpixel locating around (i.e. adjacent) a corresponding subpixel if the accumulated stress value of one of the subpixels is over a threshold.

Other aspects, advantages, and salient features of the disclosure will become better appreciated by a person of ordinary skill in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will become more apparent to the artisan from the following description taken in conjunction with the accompanying drawings, in which:

FIG. 1 is a block diagram illustrating a configuration of an electronic device according various embodiments;

FIG. 2 illustrates a configuration of a display according to various embodiments of the present disclosure;

FIG. 3 illustrates a compensation layer including subpixel compensation values according to an embodiment of the present disclosure;

FIG. 4 illustrates a compensation layer including subpixel compensation values according to an embodiment of the present disclosure;

FIG. 5 illustrates an operation for compensating an original image according to various embodiments of the present disclosure;

FIG. 6 illustrates an effect of changing a brightness of peripheral subpixels according to various embodiments of the present disclosure; and

FIG. 7 is a flow chart illustrating operations of an image processing method for an electronic device according to various embodiments of the present disclosure.

### DETAILED DESCRIPTION

Hereinafter, various embodiments of the present disclosure will be described in conjunction with the accompanying drawings. Various embodiments described in the present disclosure, however, may not be intentionally confined to specific embodiments, but should be construed as including diverse modifications, equivalents, and/or alternatives. With respect to the descriptions of the drawings, like reference numerals refer to like elements.

The terms “have”, “may have”, “include”, “may include”, “comprise”, or “may comprise” used in the present disclosure indicate existence of corresponding features (e.g., numerical values, functions, operations, or components) but does not exclude other features.

As used in the present disclosure, the terms “A or B”, “at least one of A or/and B”, or “one or more of A or/and B” may include all allowable combinations which are enumerated together. For example, the terms “A or B”, “at least one of A and B”, or “at least one of A or B” may indicate all cases of: (1) including at least one A, (2) including at least one B, or (3) including both at least one A, and at least one B.

As used in the present disclosure, the terms such as “1st”, “2nd”, “first”, “second”, and the like may be used to qualify various elements regardless of their order and/or priority, simply differentiating one from another, but do not limit those elements thereto. For example, both a first user device and a second user device indicate different user devices. For example, a first element may be referred to as a second element and vice versa without departing from the scope of the present disclosure.

As used herein, if one element (e.g., a first element) is referred to as being “operatively or communicatively connected with/to” or “connected with/to” another element (e.g., a second element), it should be understood that the former may be directly coupled with the latter, or connected with the latter via an intervening element (e.g., a third element). Otherwise, it will be understood that if one element is referred to as being “directly coupled with/to” or “directly connected with/to” with another element, it may be understood that there is no intervening element (e.g., a third element) existing between them.

In the description or claims in the present disclosure, the term “configured to” (or “set to”) may be changeable with other implicative meanings such as “suitable for”, “having the capacity to”, “designed to”, “adapted to”, “made to”, or “capable of”, and may not simply indicate “specifically designed to”. Alternatively, in some circumstances, a term “a device configured to” may indicate that the device “may do” something together with other devices or components. For instance, a term “a processor configured to (or set to) perform A, B, and C” may indicate a generic-purpose processor (e.g., CPU or application processor) capable of performing its relevant operations by executing one or more software or programs which is stored in an exclusive processor (e.g., embedded processor), which is prepared for the operations, or in a memory.

The terms used in this specification are just used to describe various embodiments of the present disclosure and may not be intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevantly related art and not in an idealized or overly formal detect unless expressly so defined herein in various embodiments of the present disclosure. In some cases, terms even defined in the specification may not be understood as excluding embodiments of the present disclosure.

An electronic device according to various embodiments of the present disclosure may include, for example, at least one of smartphones, tablet personal computers (tablet PC), mobile phones, video telephones, electronic book readers, desktop PCs, laptop PCs, netbook computers, workstations, servers, personal digital assistants (PDA), portable multimedia players (PMP), MP3 players, mobile medical devices, cameras, and wearable devices, just to name a few non-limiting possibilities. According to various embodiments, the wearable devices may include at least one of accessories (e.g., watches, rings, bracelets, anklets, necklaces, glasses, contact lenses, or head-mounted devices (HMD)), assembled textiles or clothes (e.g., electronic apparel), body-attachable matters (e.g., skin pads or tattoos), or implantable devices (e.g., implantable circuits).

In some embodiments of the present disclosure, an electronic device may be a smart home appliance. The smart home appliance, for example, may include at least one of televisions (TV), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, Google TV™, and the like), game consoles (e.g., Xbox™, PlayStation™, and the like), electronic dictionaries, electronic keys, camcorders, electronic picture frames, and the like.

In other embodiments of the present disclosure, an electronic device may include at least one of a diverse group of medical devices (e.g., portable medical measuring instruments (blood-sugar measuring instruments, heart-pulsation measuring instruments, blood-pressure measuring instruments, or body-temperature measuring instruments), magnetic resonance angiography (MRA) equipment, magnetic resonance imaging (MRI) equipment, computed tomography (CT) equipment, scanners, and ultrasonic devices), navigation device, global positioning system (GPS) receiver, event data recorder (EDR), flight data recorders (FDR), vehicle infotainment devices, electronic equipment for vessels (e.g., navigation systems and gyrocompasses), avionics, security devices, head units for vehicles, industrial or home robots, automatic teller's machines (ATM) for financial agencies, points of sales (POS) for stores, and internet of things (e.g., electric bulbs, diverse sensors, electric or gas meter, spring cooler units, fire alarms, thermostats, road lamps, toasters, exercise implements, hot water tanks, boilers, and the like).

According to some embodiments of the present disclosure, an electronic device may include at least one of parts of furniture or buildings/structures having communication functions, electronic boards, electronic-signature receiving devices, projectors, and diverse measuring instruments (e.g., water meters, electricity meters, gas meters, and wave meters) including metal cases. In various embodiments, an electronic device may be one or more combinations of the above-mentioned devices. Electronic devices according to some embodiments may be flexible electronic devices. Additionally, electronic devices according to various embodiments of the present disclosure may not be restrictive to the above-mentioned devices, rather may include new electronic devices emerging by way of technical development.

Hereinafter, an electronic device according to various embodiments will be described in conjunction with the accompanying drawings. In description for various embodiments, the term “user” may refer to a person using an electronic device or a device (e.g., an artificial intelligent electronic device) using an electronic device.

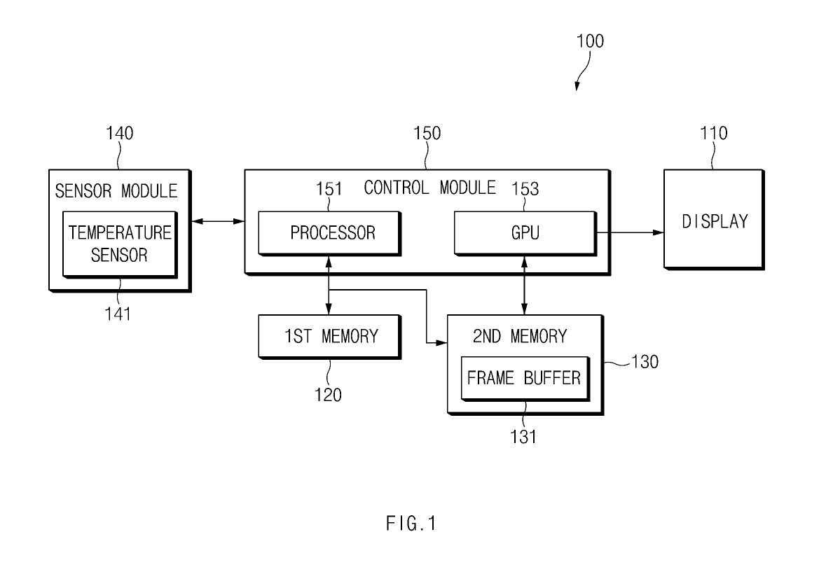

FIG. 1 is a block diagram illustrating a configuration of an electronic device according to various embodiments of the present disclosure.

Referring now to FIG. 1, an electronic device 100 may include a display 110, a first memory 120, a second memory 130, a sensor module 140, and a control module 150.

The display 110 may display an image (e.g., content, user interface, etc.). According to an embodiment, the display 110 may display an image which is stored in a frame buffer 131, and may comprise a touchscreen.

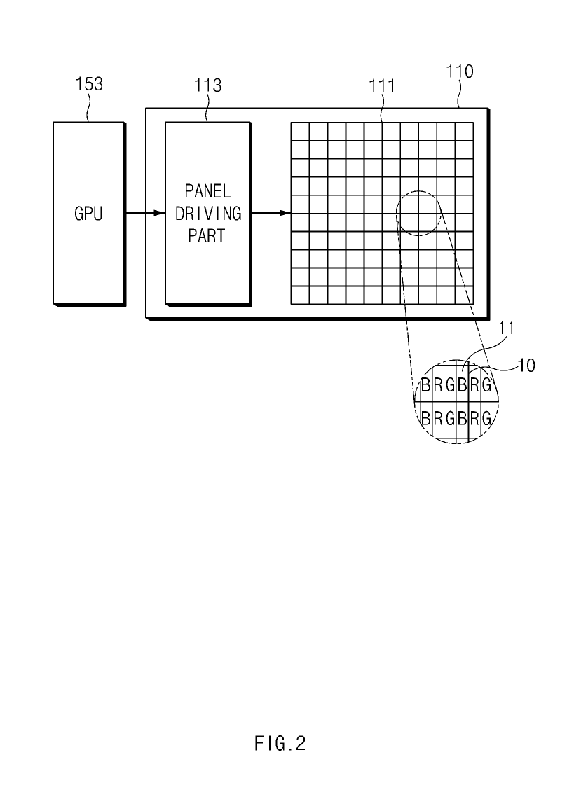

FIG. 2 illustrates a configuration of a display according to various embodiments of the present disclosure.

Referring now to FIG. 2, the display 110 may include a display panel 111 and a panel driving part 113.

According to an embodiment, the display panel 111 may include an OLED panel (e.g., active-matrix OLED (AMOLED)). According to an embodiment, the display panel 113 may include a plurality of pixels 10. The plurality of pixels 10 included in the display panel 111 may each include a plurality of subpixels 11. For example, one pixel 10 may include a plurality of subpixels 11 (e.g., two, three, or four subpixels). According to an embodiment, each subpixel 11 included in the display panel 111 may include a light emitting element and a thin film transistor (TFT). For example, the light emitting element included in the subpixel 11 may display one of red, green, and blue. For the case of pentile subpixel, a light emitting element included in the subpixel 11 may display one of red, green, blue, and white. Brightness of the light emitting element included in the subpixel 11 may be determined by an amount of current supplied thereto. For example, a light emitting element may become brighter or darker in proportion to an amount of current supplied thereto.

According to an embodiment of the disclosure, the panel driving part 113 may drive the display panel 111 to display an image. According to an embodiment, the panel driving part 113 may individually supply a current to each of the plurality of subpixels 11 included in the display panel 111. For example, the panel driving part 113 may control TFTs, which are included respectively in the subpixels 11, to control an amount of current which is supplied into the subpixels 11. According to an embodiment of the disclosure, the panel driving part 113 may control an amount of current, which is supplied into the subpixels 11, according to pixel values (e.g., R, G, B) of an image received from a graphic processing unit (GPU) 153. For example, the panel driving part 113 may supply a larger current as the pixel value becomes larger, and may supply a smaller current as the pixel value becomes smaller. In other words, the panel driving part 113 may supply the maximum current if the pixel value is 255, but may not supply any current if the pixel value is 0.

According to an embodiment, the first memory 120 may be a nonvolatile memory and is non-transitory. For example, the first memory 120 may be a flash memory. For example, the first memory 120 may include an embedded multimedia card (eMMC), a universal flash storage (UFS), or a secure digital (SD) card.

According to an embodiment, the first memory 120 may store accumulated stress values for respective subpixels of the display panel 111. For example, the first memory 120 may update accumulated stress values whenever stress values are calculated by a control module 150.

According to an embodiment, the first memory 120 may store accumulated stress values in a user field (or a field which can be deleted by a user) or in a system field (or a field which cannot be deleted by a user). According to an embodiment, if accumulated stress values are stored in a user field, the first memory 120 may periodically back up and store accumulated stress values, which are stored in the user field, to and in a system field (or a field which cannot be deleted by a user).

According to an embodiment, the second memory 130 may be a volatile memory. For example, the second memory 130 may be a random access memory (RAM). According to an embodiment, the second memory 130 may store accumulated stress values which are copied from the first memory 120. According to an embodiment, the second memory 120 may store a compensation layer. The compensation layer may include compensation values for correcting pixel values of an original image. According to an embodiment, the compensation layer may include compensation values in the unit of pixel or subpixel. According to an embodiment of the disclosure, the compensation value may have 0 to 1.

According to an embodiment of the disclosure, the second memory 130 may include a frame buffer 131. The frame buffer 131, for example, may be a memory field which is fixedly settled in the second memory 130. According to an embodiment, the frame buffer 131 may store an original image. The original image may mean an image of which the pixel value is not corrected by the GPU 153.

According to an embodiment, the frame buffer 131 may store pixel values in the unit of pixel (or subpixel) of the display panel 111. The pixel values, for example, may have 0 to 155. The pixel values of 0 to 255, for example, may be stored with binary data of 8 bits. According to an embodiment, an original image (or respective pixel values) stored in the frame buffer 131 may be transferred to the GPU 153.

Although the aforementioned embodiment is described as the frame buffer 131 is included in the second memory 130, the frame buffer 131 may be included in the electronic device 100 as an additional element out of the second memory 130.

The sensor module 140 may detect a state of the electronic device 100. According to an embodiment, the sensor module 140 may include at least one temperature sensor 141. The temperature sensor 141 may be attached to at least a part of the electronic device 100 to detect temperature of the electronic device 100. For example, the temperature sensor 141 may be attached to the display panel 111 to detect temperature of the display panel 111. The module in this case is hardware may constitute a housing for the sensor and/or a buffer storage.

The control module 150, which includes hardware circuitry such as a processor or microprocessor, configured for operation may control a general operation of the electronic device 100. For example, the control module 150 may control the display 110, the first memory 120, the second memory 130, and the sensor module 140 to change brightness of at least one subpixel 11 which is included in the display 110 according to various embodiments of the present disclosure. For example, if at least one accumulated stress value stored in the first memory 120 goes over a threshold, the control module 150 may control the display 110, the first memory 120, the second memory 130, and the sensor module 140 to change brightness of at least one subpixel 11 locating around (i.e. adjacent) a corresponding subpixel. As brightness of a subpixel is determined by an amount of current which is supplied to the subpixel, changing the brightness of the subpixel may be regarded as the same with the changing of a current amount which is supplied to the subpixel. Peripheral subpixels may include different subpixels included in the same pixel, as well as subpixels included in different pixels.

According to an embodiment of the disclosure, the control module 151 may include a processor 151 (or central processing unit (CPU)) and a GPU. According to an embodiment, the control module 150 may be a system-on-chip (SOC) including a CPU, a GPU, a sensor hub video processor, etc., just to name some non-limiting possibilities.

The processor 151 may be a main processor of the electronic device 100, and includes integrated circuitry configuration for operation. There may be more than one processor that is communicatively operation with each other. According to an embodiment, the processor 151 may calculate stress values of a plurality of subpixels which are included in the display panel 111. According to an embodiment, the processor 151 may calculate stress values of subpixels in a time interval (e.g., 1 second interval).

According to an embodiment of the disclosure, the processor 151 may calculate a stress value of a subpixel based on at least one of a pixel value of the subpixel, brightness of the display, and temperature of the display. According to an embodiment, the processor 151 may calculate a stress value based on a pixel value of an image transferred to the display 110. According to an embodiment, the processor 151 may use, for example, only first two bits of binary data representing a pixel value of a subpixel. According to an embodiment, the processor 151 may calculate a high stress value as large as a pixel value of a subpixel, and may calculate a low stress value as small as a pixel value of a subpixel. The brightness of the display may be irrelevant to a pixel value and may mean brightness, which is set by the processor 151, of the display 110 itself. The brightness may be same throughout the display 110. The brightness, for example, may be changed by peripheral brightness of the electronic device 100. According to an embodiment, the processor 151 may calculate a higher stress value as high as brightness of the display, and may calculate a lower stress value as low as brightness of the display. According to an embodiment, the processor 151 may receive information about temperature of the display from at least one temperature sensor 141 which is close to the display 110. According to an embodiment, the processor 151 may calculate a higher stress value as high as a temperature of the display and may calculate a lower stress value as low as a temperature of the display.

According to an embodiment of the disclosure, the processor 151 may accumulatively store the calculated stress values in the first memory 120. For example, the processor 151 may update accumulated stress values, which are stored in the first memory 120, whenever stress values of subpixels are calculated.

According to an embodiment of the disclosure, the processor 151 may confirm accumulated stress values stored in the first memory 120, and then may control a pixel value of an image to be corrected if an accumulated stress value of at least one subpixel goes over a threshold. For example, the processor 151 may transfer a pixel-value correction instruction of an image, which is to be displayed on the display 110, to the GPU 153, and may control sub-pixel accumulated stress values, which are stored in the first memory 120, to be copied into the second memory 130. Copying accumulated stress values, for example, may be performed by a module (not shown) in response to an instruction of the processor 151. According to an embodiment, a threshold may be differently set according to a kind of subpixel (e.g., red, green, or blue). For example, a blue subpixel may be set with a threshold lower than that of a red or green subpixel.

In the case that a subpixel accumulated stress value goes over a threshold, it may be determined that a light emitting element of the subpixel is degraded in functionality and insufficient to generate light of a normal (i.e. predetermined) brightness. For example, although a corresponding subpixel is supplied with a current amount of 1, the subpixel may emit light which is generated when a current amount less than 1 is supplied thereto. Accordingly, the processor 151 may determine that a burn-in effect is caused due to a subpixel whose accumulated stress value goes over a threshold, and then may control a pixel value of the subpixel to be corrected.

The GPU 153 may process an original image, which is stored in the frame buffer 131, and may transfer a processed imaged to the display 110. According to an embodiment, the GPU 153 may correct pixel values of an original image according to an instruction of the processor 151. If a pixel-value correction instruction is received from the processor 151, the GPU 153 may generate a compensation layer based on subpixel accumulated stress values which are stored in the second memory 130. According to an embodiment, the compensation layer may include compensation values for correcting pixel values of an original image. According to an embodiment, compensation values may have 0 to 1 for changing brightness of subpixels. In the case that a compensation value is 1, brightness of a subpixel corresponding thereto may not be changed. In the case that a compensation value is less than 1, a brightness of a subpixel corresponding thereto may be decreased. According to an embodiment, the GPU 153 may generate a compensation layer which includes compensation values in the unit of pixel or subpixel.

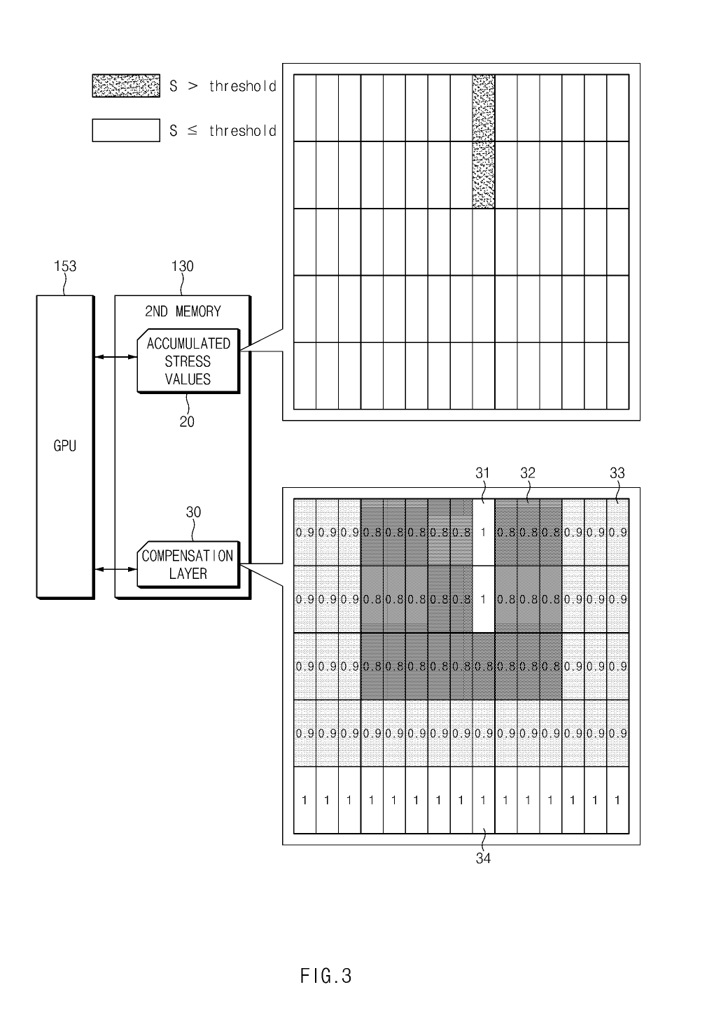

FIG. 3 illustrates a compensation layer including subpixel compensation values according to an embodiment of the present disclosure.

Referring now to FIG. 3, a second memory 130 may store accumulated stress values 20. A GPU 153 may generate compensation layer 30 from the accumulated stress values 20 which are stored in the second memory 20, and then may store the compensation layer 30 in the second memory 20. According to an embodiment of the disclosure, the GPU 30 may set compensation values of the compensation layer 30.

According to an embodiment of the disclosure, the GPU 153 may set a compensation value 31 of a subpixel, which has an accumulated stress value (S) over a threshold, to 1. In the case where a subpixel whose accumulated stress value goes over a threshold, the subpixel may not generate light in normal brightness. Therefore, the GPU 153 may set the corresponding subpixel to have its compensation value at the maximum brightness.

According to an embodiment of the disclosure, the GPU 153 may set a compensation value of at least one peripheral subpixel, which locates around a subpixel whose accumulated stress value (S) goes over a threshold, less than 1. For example, in the case where a subpixel whose accumulated stress value goes over a threshold, the subpixel may not generate light in normal brightness. Therefore, the GPU 153 may decrease the brightness of the peripheral subpixels to lessen a difference from the subpixel whose accumulated stress value goes over the threshold.

According to an embodiment of the disclosure, the GPU 153 may set a compensation value 32 or 33 of at least one peripheral subpixel, which locates in a distance from a subpixel whose accumulated stress value (S) goes over a threshold, to a value (e.g., 0.8 or 0.9) less than 1, while may set a compensation value 34 of a peripheral subpixel, which locates out of the distance, to 1. In the case where a peripheral subpixel locating out of a distance from a subpixel whose accumulated stress value goes over a threshold, the peripheral subpixel may not be changed in brightness because the peripheral subpixel does not affect a burn-in effect.

According to an embodiment, the GPU 153 may set a compensation of a peripheral subpixel to be larger as a distance from a subpixel whose accumulated stress value (S) goes over a threshold. In other words, a compensation value of a peripheral subpixel may be proportional to a distance from a subpixel whose accumulated stress value (S) goes over a threshold. For example, a compensation value of a peripheral subpixel may increase from 0.8 toward 1 as a distance from a subpixel whose accumulated stress value (S) goes over a threshold. Thus, the brightness of the peripheral subpixel may gradually increase to prevent a user from recognizing a burn-in effect.

According to an embodiment of the disclosure, the GPU 153 may set a compensation value of a peripheral subpixel according to an accumulated stress value of a corresponding subpixel. For example, as large as an accumulated stress value of a subpixel, a compensation value of the peripheral subpixel may be set lower. For example, an accumulated stress value of a subpixel may be inversely proportional to a compensation value of its peripheral subpixel.

According to an embodiment of the disclosure, the GPU 153 may set compensation values in consideration of subpixel values of an original image to be applied with the compensation layer 30. For example, in the case of generating light, which corresponds to a subpixel of an original image, by a subpixel whose accumulated stress value goes over a threshold, a compensation value of a peripheral subpixel may be set on 1 to render brightness of the peripheral subpixel to be unchanged.

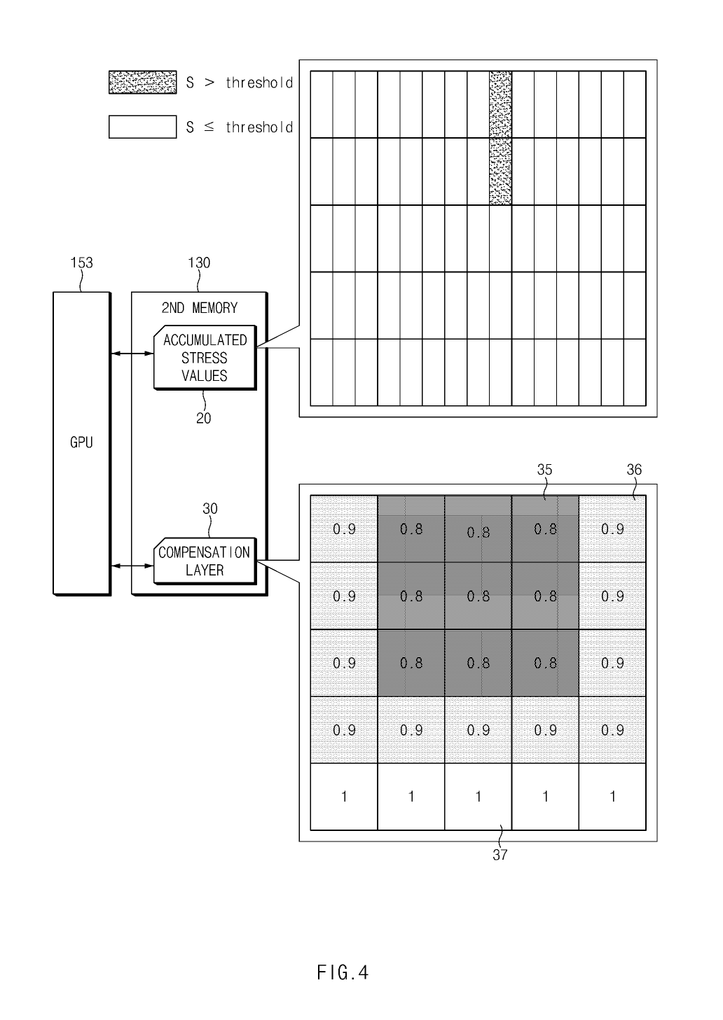

FIG. 4 illustrates a compensation layer including subpixel compensation values according to an embodiment of the present disclosure.

Referring now to FIG. 4, a second memory 130 may store accumulated stress values 20. A GPU 153 may generate a compensation layer 30 from the accumulated stress values 20 which are stored in the second memory 20, and may store the compensation layer 30 in the second memory 20. According to an embodiment, the GPU 30 may set compensation values of the compensation layer 30. Compensation values for respective pixels may be applicable to subpixels included in corresponding pixels.

According to an embodiment of the disclosure, the GPU 153 may set a compensation value 35, 36 (FIG. 4) of at least one peripheral subpixel, which locates around (adjacent) a pixel whose accumulated stress value (S) goes over a threshold and around a subpixel whose accumulated stress value (S) goes over a threshold, to a value (e.g., 0.8 or 0.9) less than 1. In the case for a subpixel whose accumulated stress value goes over a threshold value, the subpixel may not generate light in normal brightness. Therefore, brightness of its peripheral subpixel may decrease to lessen a difference of brightness from a peripheral subpixel whose accumulated stress value goes over a threshold value.

According to an embodiment, the GPU 153 may set a compensation value 35, 36 (FIG. 4) of at least peripheral pixel, which locates in a distance from a subpixel whose accumulated stress value (S) goes over a threshold, to a value smaller than 1, but may set a compensation value of a peripheral pixel, which locates out of the distance, to 1. As the peripheral subpixel locates out of the distance does not affect a burn-in effect, the peripheral subpixel may not be changed in brightness.

According to an embodiment, the GPU 153 may set a compensation of a peripheral pixel to be larger as a distance from a subpixel whose accumulated stress value (S) goes over a threshold. For example, a compensation value of a peripheral pixel may be proportional to a distance from a subpixel whose accumulated stress value (S) goes over a threshold. For example, a compensation value of a peripheral pixel may increase from 0.8 toward 1 as a distance from a subpixel whose accumulated stress value (S) goes over a threshold. In other words, the brightness of the peripheral pixel may gradually increase to prevent a user from recognizing a burn-in effect.

According to an embodiment of the disclosure, the GPU 153 may set a compensation value of a peripheral pixel according to an accumulated stress value of a corresponding subpixel. For example, as large as an accumulated stress value of a subpixel, a compensation value of the peripheral pixel may be set lower. For example, an accumulated stress value of a subpixel may be inversely proportional to a compensation value of its peripheral pixel.

According to an embodiment, the GPU 153 may set compensation values in consideration of subpixel values of an original image to be applied with the compensation layer 30. For example, in the case capable of generating light, which corresponds to a subpixel of an original image, by a subpixel whose accumulated stress value goes over a threshold, a compensation value of a peripheral pixel may be set on 1 to render brightness of the peripheral pixel to be unchanged.

Comparing the embodiments of FIGS. 3 and 4, although an amount of processing data may increase in the case of setting compensation values of the compensation layer respectively for subpixels, correction compensation may be performed, respectively, for subpixels. On the contrary, in the case of setting compensation values of the compensation layer respectively for pixels, the brightness of a subpixel whose accumulated stress value goes over a threshold may decrease to hinder the accuracy of the correction, but it may be allowable to reduce an amount of processing data. That is, it may be possible to variably set a unit of compensation value according to the functionality of the GPU 153.

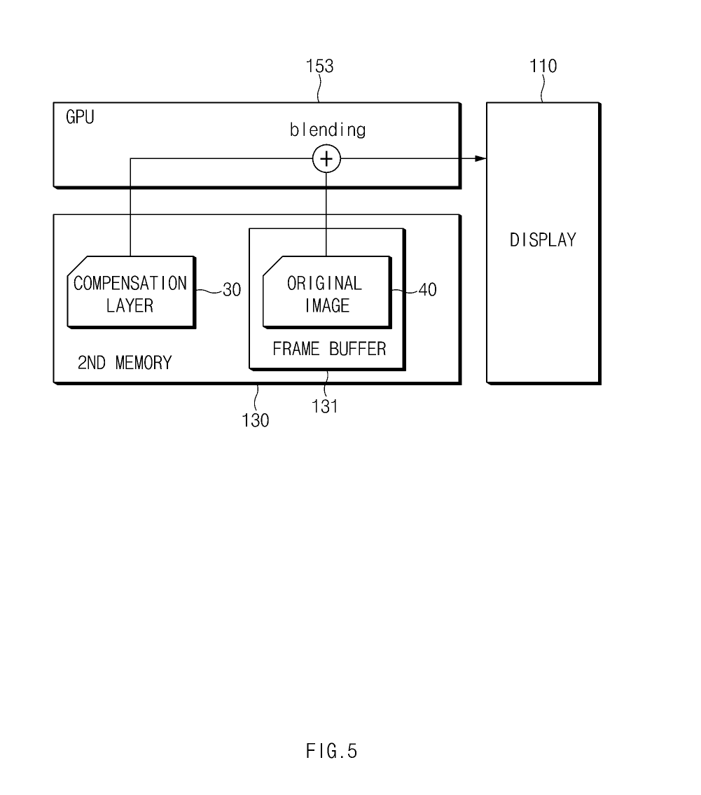

FIG. 5 illustrates an operation for compensating an original image according to various embodiments of the present disclosure.

According to an embodiment of the disclosure, a GPU 153 may blend a compensation layer 30, which is stored in a second memory 130, and an original image 40 stored in a frame buffer 131, to correct pixel values of the original image. According to an embodiment, the GPU 153 may transfer an image (or corrected image), of which the pixel value is corrected, to a display 110.

According to an embodiment of the disclosure, the GPU 153 may be embodied as a hardware module (e.g., display controller) which is configured to perform an alpha blending operation. According to an embodiment, the hardware module may perform an alpha blending operation for each pixel according to Equation 1.

[Equation 1]

R₁,G₁,B₁=(R₀,G₀,B₀)×A_{R}+(0,G₀,B₀)×(1−A_{R}) (1)

R₂,G₂,B₂=(R₁,G₁,B₁)×A_{G}+(R₁,0,B₁)×(1−A_{G}) (2)

R_{C},G_{C},B_{C}=(R₂,G₂,B₂)×A_{B}+(R₂,G₂,0)×(1−A_{B}) (3)

In Equation 1, RO, Go, and BO respectively denote red, green, and blue subpixel values of an original image, and AR, AG, and AB respectively denote compensation values of the red, green, and blue subpixels of an original image. According to Equation 1, pixel values (i.e., RC, GC. or BC) of a corrected image may be calculated as R×AR, G×AG, and B×AB.

According to an embodiment, the hardware module may perform an alpha bending operation for each pixel according to Equation 2.

R_{C},G_{C},B_{C}=(R₀,G₀,B₀)×α+(0,0,0)×(1−α) [Equation 2]

In Equation 2, RO, Go, and BO respectively denote red, green, and blue subpixel values of an original image, and α denotes an alpha value for each pixel and may be determined based on a compensation value for each pixel (or subpixel). RC, GC, and BC denote red, green, and blue subpixel values, respectively. According to Equation 2, pixel values (i.e., RC, GC. or BC) of a corrected image may be calculated as R×a, G×a, and B×α.

According to an embodiment of the disclosure, the GPU 153 may perform a blending operation by multiplying a compensation value and a pixel value of an original image for each pixel. For example, in the case that pixel values of an original image for red, green, and blue subpixels included in one pixel are R, G, and B, respectively, and compensation values are AR, AG, and AB, pixel values of a corrected image may be R×AR, G×AG, and B×AB. In the case that a compensation value of a specific subpixel (or a pixel including a subpixel) is 1, a pixel value of a corrected image may be same as that of an original image. In the case that a compensation value of a specific subpixel is less than 1, a pixel value of a corrected image may decrease by a ratio of the compensation value from that of an original image. This blending operation may be performed by software through the GPU 153.

According to an embodiment of the disclosure, the GPU 153 may perform one of the three blending modes in accordance with functionality of the GPU 153, battery residual, and resolution of the display 110.

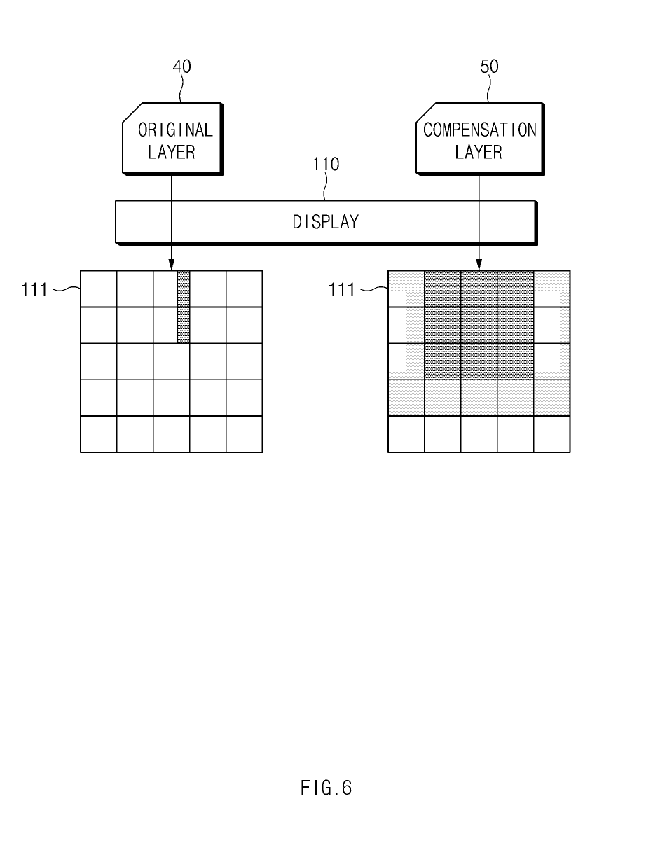

FIG. 6 illustrates an effect of changing brightness of peripheral subpixels according to various embodiments of the present disclosure.

Referring now to FIG. 6, when a burn-in effect occurs, there are exemplary

shown brightness of a display panel 111 in the case of displaying an original image 40 on a display, and brightness of the display panel 111 in the case of displaying a corrected image 50 on the display.

In the case of displaying the original image 40 on the display, a specific subpixel is degraded in functionality and in this case is darker than peripheral pixels, changing in color. Then a user may eventually recognize a burn-in effect. Otherwise, when displaying a corrected image 50 on the display, peripheral subpixels are displayed similar to the specific subpixel, which is degraded in functionality, in brightness, thus maintaining a color of the pixel and preventing the user from recognizing a burn-in effect.

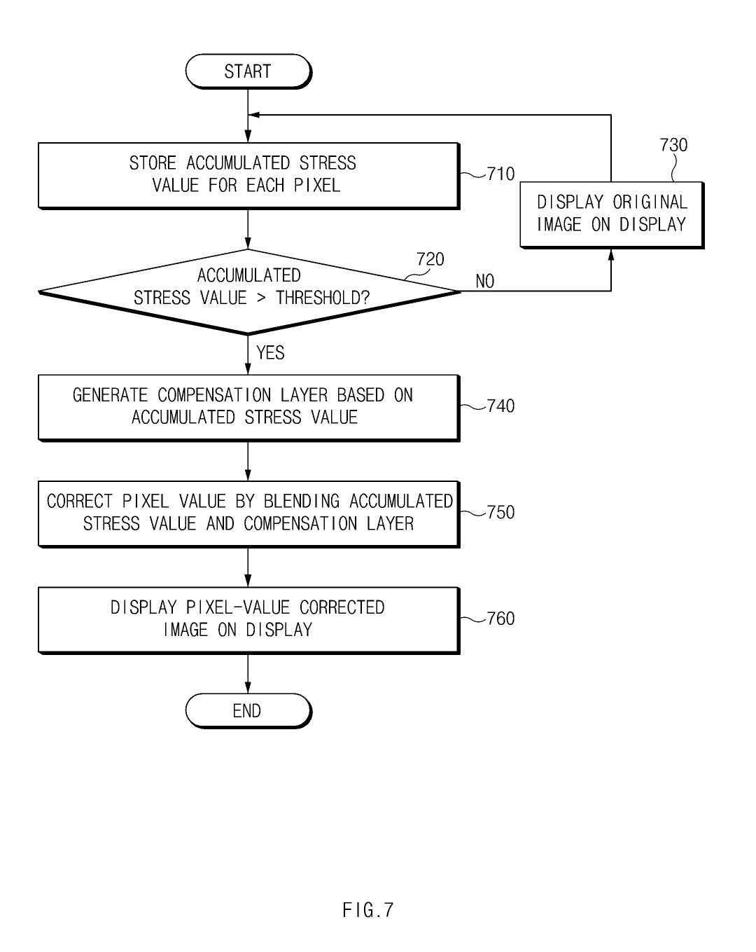

FIG. 7 is a flow chart showing an image processing method for an electronic device according to various embodiments of the present disclosure.

The flow chart shown in FIG. 7 illustrates operations processed in the electronic device 100 shown in FIG. 1. Although omitted hereafter, the description about the electronic device 100 aforementioned in conjunction with FIGS. 1 to 6 may be applicable to the flow chart of FIG. 7.

Referring now to FIG. 7, at operation 710, the electronic device 100 may store accumulated stress values for respective subpixels. According to an embodiment, the electronic device 100 may calculate stress values for a plurality of subpixels included in a display 110 (or display panel 111). According to an embodiment, the electronic device 100 may calculate stress values of subpixels in a time interval (e.g., 1 second). According to an embodiment, the electronic device 100 may calculate stress values of subpixels based on at least one of pixel values of the subpixels, brightness of the display, and temperature of the display. According to an embodiment, the electronic device 100 may calculate stress values based on subpixel values of an image which is transferred to the display 110 from a GPU 153.

According to an embodiment, the electronic device 100 may accumulatively store the calculated stress values in a first memory 120. For example, the electronic device 100 may update the accumulated stress values, which are stored in the first memory 120, whenever calculating stress values of subpixels.

According to an embodiment, at operation 720, the electronic device 100 may determine whether an accumulated stress value of at least one subpixel goes over a threshold. According to an embodiment, the threshold may be differently set according to a type (e.g., red, green, or blue) of subpixel. For example, a blue subpixel may be set lower than a red or green subpixel in threshold.

According to an embodiment of the disclosure, at operation 730 if there is no subpixel whose accumulated stress value goes over a threshold, the electronic device 100 may display an original image on the display. Then, at the operation 710, the electronic device 100 may update the accumulated stress value according to a subpixel value of the image displayed on the display.

According to an embodiment of the disclosure, if an accumulated stress value of at least one subpixel goes over a threshold, the electronic device 100 may generate a compensation layer based on the accumulated stress values for respective subpixels at operation 740. According to an embodiment, a compensation layer may include compensation values for correcting pixel values of an original image. According to an embodiment, compensation values may be prepared to change brightness of subpixels and may be valued in 0 to 1. According to an embodiment, the electronic device 100 may generate a compensation layer which includes compensation values in the unit of pixel or subpixel.

According to an embodiment of the disclosure, the electronic device 100 may set a compensation value of at least one peripheral subpixel (or peripheral pixel), which locates in a distance from a subpixel whose accumulated stress value goes over a threshold, to a value (e.g., 0.8 or 0.9) less than 1. According to an embodiment, the electronic device 100 may set a compensation value of a peripheral subpixel (or peripheral pixel) larger as a distance from a subpixel whose accumulated stress value goes over a threshold. According to an embodiment, the electronic device 100 may set compensation values of peripheral subpixels (or peripheral pixels) according to accumulated stress values of the subpixels. For example, an accumulated stress value of a subpixel may be inversely proportional to a compensation value of a peripheral subpixel (or peripheral pixel). According to an embodiment, the electronic device 100 may set compensation values in consideration of subpixel values of an original image to which a compensation layer is applied. For example, in the case of generating light, which corresponds to a subpixel value of an original image, by a subpixel whose accumulated stress value goes over a threshold, the electronic device 100 may set a compensation value of a peripheral subpixel (or peripheral pixel) to 1.

With continued reference to the flow chart of FIG. 7, at operation 750, the electronic device 100 may correct pixel values of an original image by blending the original image and a compensation layer.

At operation 760, the electronic device 100 may display an image, of which the pixel value is corrected, on the display. In the case of displaying a pixel-value corrected image (or corrected image) on the display, the corrected image may be displayed in brightness similar to a subpixel with a peripheral subpixel which is degraded in functionality. Thereby, the color of a corresponding pixel is maintained in itself to prevent a user from recognizing a burn-in effect.

Each of the above-described elements of the electronic device according to an embodiment of the present disclosure may be implemented using one or more components, and a name of a relevant component may vary with on the kind of the electronic device. The electronic device according to various embodiments of the present disclosure may include at least one of the above components. Also, one or more of the components may be omitted, or additional other components may be further included. Also, some of the components of the electronic device according to the present disclosure may be combined to form one entity, thereby making it possible to perform the functions of the relevant components substantially the same as before the combination.

The apparatuses and methods of the disclosure can be implemented in hardware, and in part as firmware or via the execution of software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101 and none of the elements are software per se. No claim element herein is to be construed under the provisions of 35 U.S.C. 112, sixth paragraph, unless the element is expressly recited using the phrase “means for”.

The definition of the terms “unit” or “module” as referred to herein are to be understood as constituting hardware circuitry, such as, a CCD, CMOS, SoC, AISC, FPGA, a processor or microprocessor (a controller or control unit) with integrated circuitry configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se. The term “module” used for the present disclosure, for example, may mean a unit including hardware, software, and firmware or a combination of two or more thereof. A “module”, for example, may be interchangeably used with terminologies such as a unit, logic, a logical block, a component, a circuit, etc. The “module” may be a minimum unit of a component integrally configured or a part thereof. The “module” may be a minimum unit performing one or more functions or a portion thereof. The “module” may be implemented mechanically or electronically. For example, the “module” according to various embodiments of the present disclosure may include at least one of an application-specific integrated circuit (ASIC) chip performing certain operations, a field-programmable gate arrays (FPGAs), or a programmable-logic device, those of which have been known or to be developed in the future. In FIG. 1, the control module 150 may comprise one integrated circuit, or may include two chips, for example the integrated circuits of integrated, processor 151 and the Graphics Processing Unit 153. The GPU can be a programmable logic chip.

At least a part of an apparatus (e.g., modules or functions thereof) or a method (e.g., operations) according to various embodiments of the present disclosure, for example, may be implemented by instructions stored in a computer-readable storage medium in the form of a programmable module. In the case that the instruction is executed by a processor (e.g., the processor 151), one or more processor may perform a function corresponding to the instruction.

The computer-readable recording medium may include a non-transitory medium such as a hard disk, a magnetic media such as a floppy disk and a magnetic tape, an optical media such as compact disc read only memory (CD-ROM) and a digital versatile disc (DVD), a magneto-optical media such as a floptical disk, and the following hardware devices specifically configured to store and perform a program instruction (e.g., a programming module): read only memory (ROM), random access memory (RAM), and a flash memory. Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a programming module according to various embodiments of the present disclosure may include at least one of the above elements, or a part of the above elements may be omitted, or additional other elements may be further included. Operations performed by a module, a programming module, or other elements according to an embodiment of the present disclosure may be executed sequentially, in parallel, repeatedly, or in a heuristic method. Also, a portion of operations may be executed in different sequences, omitted, or other operations may be added thereto.

According to various embodiments of the present disclosure, it may be accomplishable to lessen a burn-in effect through image processing in a display. Accordingly, a user may be prevented from recognizing a burn-in effect, thus reducing defects and improving satisfaction for a display product.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display configured to display an image formed by a plurality of pixels, each one of the plurality of the pixels being comprised of subpixels;
a non-volatile memory configured to store accumulated stress values for respective subpixels that are included in the plurality of pixels; and
at least one processor configured to change a brightness of at least one peripheral subpixel arranged adjacent a corresponding subpixel if the accumulated stress value of at least one subpixel is over a threshold value.

2. The electronic device of claim 1, wherein the at least one processor is configured to calculate stress values for the respective subpixels at predefined time intervals and accumulatively stores the calculated stress values in the non-volatile memory.

3. The electronic device of claim 2, wherein the at least one processor is configured to calculate the stress values based on at least one of pixel values of the subpixels, a brightness of the display, and a temperature of the display.

4. The electronic device of claim 1, wherein the threshold value is differently set according to a particular type of the subpixel.

5. The electronic device of claim 1, wherein the at least one processor is configured to correct pixel values of an original image based on the accumulated stress values and to transfer an image, of which the pixel values are corrected, to the display.

6. The electronic device of claim 5, wherein the at least one processor is configured to generate a compensation layer based on the accumulated stress values and to correct the pixel values of the original image by blending the original image and the compensation layer.

7. The electronic device of claim 6, wherein the compensation layer includes compensation values to correct the pixel values in units of pixels or subpixels.

8. The electronic device of claim 7, wherein the at least one processor is configured to set a compensation value of the peripheral subpixel in an inverse proportion to the accumulated stress value of a subpixel that is over a threshold value.

9. The electronic device of claim 7, wherein the at least one processor is configured to set the compensation value to change a brightness of a peripheral subpixel located at a predefined distance from a subpixel of which a accumulated stress value is over a threshold value.

10. The electronic device of claim 7, wherein the at least one processor is configured to set a compensation value of the peripheral subpixel in proportion to a distance from a subpixel whose accumulated stress value is over a threshold value.

11. An image processing method for an electronic device, the method comprising:
storing in a non-transitory memory accumulated stress values for respective subpixels that are included in a display; and
changing a brightness of at least one peripheral subpixel located adjacent a corresponding subpixel if the accumulated stress value of one of the subpixels is over a threshold value.

12. The image processing method of claim 11, wherein the storing of the accumulated stress values comprises:
calculating stress values for respective subpixels at predefined time intervals; and
accumulatively storing the calculated stress values in the memory.

13. The image processing method of claim 12, wherein the calculating of the stress values comprises:
calculating the stress values based on at least one of pixel values of the subpixels, a brightness of the display, and a temperature of the display.

14. The image processing method of claim 11, wherein the changing of the brightness of the at least one peripheral pixel comprises:
correcting pixel values of the subpixels of an original image based on the accumulated stress values; and
displaying an image of which the pixel values are corrected.

15. The image processing method of claim 14, wherein the correcting of the pixel values comprises:
generating a compensation layer based on the accumulated stress values; and
blending the original image and the compensation layer to correct the pixel values.

16. The image processing method of claim 15, wherein the generating of the compensation layer comprises:
setting compensation values to correct the pixel values in units of pixels or subpixels.

17. The image processing method of claim 16, wherein the setting of the compensation values comprises:
setting a compensation value of the peripheral subpixel in an inverse proportion to an accumulation value of a subpixel that is over a threshold value.

18. The image processing method of claim 16, wherein the setting of the compensation values comprises:
setting the compensation value to change brightness of a peripheral subpixel locating in a predefined distance from a subpixel whose accumulated stress value is over a threshold value.

19. The image processing method of claim 16, wherein the setting of the compensation values comprises:
setting a compensation value of the peripheral subpixel in proportion to a distance from a subpixel whose accumulated stress value is over a threshold value.

20. A computer-readable recording medium storing a program, which when executed, causing an electronic device to perform a method, the method comprising:
storing in a non-transitory accumulated stress values for respective subpixels that are included in a display; and
changing a brightness of at least one peripheral subpixel arranged adjacent a corresponding subpixel if the accumulated stress value of one of the subpixels is over a threshold value.
